(19) United States
(12) Patent Application Publication
(10) Pub. No.: US 2009/0075857 A1
(43) Pub. Date: Mar. 19, 2009

(54) Clear Detergent or Cleaning Agent Having a Flow Limit

(75) Inventors: Hermann Jonke, Dusseldorf (DE); Piotr Malecki, Wegberg-Arsbeck (DE); Bernhard Orlich, Dusseldorf (DE); Thomas Plantenberg, Mettmann (DE)

Correspondence Address: CONNOLLY BOVE LODGE & HUTZ LLP, PO BOX 2207, WILMINGTON, DE, 19899-2207, US

(73) Assignee: Henkel KGaA, Dusseldorf (DE)

(21) Appl. No.: 11/886,992

(22) PCT Filed: Mar. 10, 2006
(86) PCT No.: PCT/EP2006/002217

§ 371 Date: May 22, 2008

(30) Foreign Application Priority Data
Apr. 1, 2005 (DE) 10 2005 015 328.3

(51) Int. Cl. C11D 17/08

(52) U.S. Cl. 510/337

(57) ABSTRACT

The invention relates to an aqueous detergent or cleaning agent, containing one or more surfactants, a polyacrylate as a thickening agent, a solvent component comprising dipropylene glycol, in addition to other usual detergent and cleaning agent substances. The thus obtained aqueous detergent or cleaning agent is clear, transport and storage stable, has a flow limit and can disperse particles in a stable manner and over a long period of time.

The invention relates to an aqueous, liquid detergent and cleaning agent having a flow limit, including surfactant(s) as well as further conventional ingredients of detergents and cleaning agents.

The incorporation of certain active ingredients (e.g. bleaching agents, enzymes, perfumes, colorants etc.) into liquid detergent and cleaning agents can lead to problems. For example, incompatibilities can arise between the individual active ingredient components of the liquid detergent and cleaning agent. This can lead to unwanted discolorations, agglomerations, problems of odor, and decomposition of the active washing ingredients.

However, the consumer demands liquid detergent and cleaning compositions that optimally develop their activity at the time of use even after storage and transport. This requires that beforehand the ingredients of the liquid detergent and cleaning composition have neither precipitated, decomposed nor volatilized.

The loss of volatile components, for example, can be prevented by elaborate and correspondingly expensive packaging. Chemically incompatible components can be kept separate from the remainder of the components of the liquid detergent and cleaning composition and then metered in for the application. The use of non-transparent packaging prevents the decomposition of the light-sensitive components, but has also the disadvantage that the consumer cannot see the appearance and amount of the liquid detergent and cleaning composition.

One concept for incorporating sensitive, chemically or physically incompatible and volatile ingredients consists in the use of particles and especially microcapsules, in which these ingredients are encapsulated for storage and transport stability.

Liquid, aqueous cleaning compositions from the cosmetic field are described in the British Patent GB 14 71 406. They comprise at least 2 wt. % triethanolamine lauryl sulfate, in total 8 to 50 wt. % surfactant as well as 0.1 to 5 wt. % suspended phase, for example spherical capsules with a diameter of 0.1 to 5 mm and a pH of 5.5 to 11. By adding a water-soluble acrylic acid polymer, for example Carbopol 941, one can achieve a homogeneous distribution of the suspended phase. The application does not comprise any indication on whether the liquid, aqueous cleaning agents exhibit flow limits.

WO 97/12027 discloses liquid detergents with a pH of 5 to 9 (at 10% dilution), which comprise 10 to 40 wt. % anionic surfactants, 1 to 10 wt. % amine oxides, less than 10 wt. % solvent and from 0 to 10 wt. % electrolyte. The liquid has a viscosity of 100 to 4000 cps at a shear rate of 20 s⁻¹ and is able to suspend particles up to a size of 200 μm.

One possibility for suspending particles in a liquid is to use structured liquids. Here, one distinguishes between an internal and an external structuring. An external structuring can be realized, for example, by the use of structurizing gums such as, for example, xanthan gum, guar gum, locust bean flour, gellan gum, wellan gum or carrageenan or of polyacrylate thickeners.

From the esthetic viewpoint, it is desirable for the liquid detergents, in which the particles are suspended, to be transparent or at least translucent. However, the use of structurizing gums often leads to a cloudy composition.

Transparent/translucent liquid detergents are described in WO 00/36078 and are capable of suspending particles with a size of 300 to 5000 μm, and comprise at least 15 wt. % surfactant and 0.01 to 5 wt. % of a polymeric gum. The application does not contain any indication on whether the liquid detergents exhibit flow limits.

A further disadvantage associated with the use of these structurizing or thickening agents is their sensitivity towards ionic compounds, especially towards the obligatory anionic surfactants present in cleaning applications.

High concentrations of polymeric thickeners in systems that also contain high concentrations of anionic surfactants can lead to drastic increases in viscosity, thereby strongly impairing the handling of the detergent and cleaning agent (for example pumping, pouring or dosing). It is also not always possible to produce flow limits in systems that are rich electrolytes and/or surfactants.

Thus, the liquid detergents described in WO 00/36078 only possess low amounts of fatty acid soaps (<1.42 wt. %).

Formulations that exhibit flow limits and which contain high amounts of anionic surfactants are described in EP 1 466 959 A1. They do not comprise any polymeric thickeners, but rather possess an anionic and cationic surfactant in a specific, effective ratio so as to produce a flow limit.

An object of the present invention is to provide a clear liquid detergent and cleaning agent having a flow limit, which is stable during storage and transport, and is capable of homogeneously dispersing particles.

This object is achieved by a clear, liquid detergent and cleaning agent that comprises surfactant(s) as well as further conventional ingredients of detergents and cleaning agents, wherein the agent comprises a polyacrylate and a solvent component comprising dipropylene glycol.

It was surprisingly found that the combination of polyacrylate as the polymeric thickener with dipropylene glycol yields clear storage-stable detergents and cleaning agents having a flow limit.

Preferably, the solvent component comprises a mixture of dipropylene glycol and 1,2-propane diol.

It has been shown that the combination of dipropylene glycol and 1,2-propane diol as the solvent component yields higher flow limits than dipropylene glycol alone.

The ratio of dipropylene glycol to 1,2-propane diol is preferably 3:1 to 1:3. The ratio of dipropylene glycol to 1,2-propane diol is particularly preferably 1:1.

It has been shown that clear, liquid detergents and cleaning agents with particularly high flow limits are obtained at these ratios and especially at a ratio of dipropylene glycol to 1,2-propane diol of 1:1.

Preferably, the quantity of the solvent component is 0.5 to 15 wt. % and preferably 2 to 9 wt. %.

In addition, the preferred quantity of the polyacrylate is 0.1 to 10 wt. % and preferably 2 to 5 wt. %.

It has been shown that these quantities of solvent component and/or polyacrylate yield detergents and cleaning agents with particularly good physical and esthetic properties.

The detergent and cleaning agent is particularly preferably aqueous.

Aqueous detergents and cleaning agents can be manufactured cheaply and simply in already existing facilities.

In a preferred embodiment, the detergent and cleaning agent comprises dispersed particles, particularly preferably microcapsules or speckles that have a diameter along their largest dimension of 0.01 to 10000 μm.

Sensitive, chemically or physically incompatible as well as volatile components of the aqueous liquid detergent and cleaning agent are advantageously incorporated inside the microcapsules, are storage and transport-stable and can be homogeneously dispersed in the aqueous liquid detergent and cleaning agent. In this way, one ensures inter alia that at the time of use, the full detergent and cleaning power of the detergent and cleaning agent is available to the consumer.

In a particularly preferred embodiment, the detergent and cleaning agent comprises between 2 and 20 wt. %, advantageously between 3 and 10 wt. % and quite particularly preferably between 4 and 8 wt. % fatty acid soap.

Fatty acid soaps are an important ingredient for the washing power of a liquid, especially aqueous detergent and cleaning agent. It has surprisingly been shown that clear, stable and thickened liquid detergents and cleaning agents are obtained by using a thickening system of polyacrylate and a solvent component comprising dipropylene glycol in the presence of high amounts of fatty acid soaps. Usually, the incorporation of high amounts (>2 wt. %) of fatty acid soaps in this type of system yields cloudy and/or unstable products.

The invention also relates to the use of an inventive clear, liquid detergent and cleaning agent for cleaning textile surfaces or hard surfaces.

The invention further relates to a process for manufacturing a clear, liquid detergent and cleaning agent, including surfactant(s) as well as further conventional ingredients of detergents and cleaning agents, in which is incorporated a polyacrylate and a solvent component that comprises dipropylene glycol.

In particular, the invention also relates to the use of a polyacrylate and a solvent component that comprises dipropylene glycol for manufacturing a clear, liquid detergent and cleaning agent having a flow limit.

The inventive detergents and cleaning agents are described below in more detail by means inter alia of examples.

The detergent and cleaning agent comprises a polyacrylate as the thickener. The polyacrylates comprise polyacrylate or polymethacrylate thickeners, for example, the high molecular weight homopolymers of acrylic acid, crosslinked with a polyalkenyl polyether, in particular an allyl ether of saccharose, pentaerythritol or propylene (INCI name according to the “International Dictionary of Cosmetic Ingredients” of The Cosmetic, Toiletry and Fragrance Association (CTFA): Carbomer), which are also called carboxyvinyl polymers. Such polyacrylic acids are available inter alia from 3V Sigma Company under the trade name Polygel®, e.g. Polygel DA, and from the Noveon Company under the trade name Carbopol®, e.g. Carbopol 940 (molecular weight ca. 4 000 000), Carbopol 941 (molecular weight ca. 1 250 000) or Carbopol 934 (molecular weight ca. 3 000 000).). In addition, the following acrylic acid copolymers are included: (i) copolymers of two or more monomers from the group of acrylic acid, methacrylic acid and their simple esters, preferably formed from C₁₋₄ alkanols (INCI Acrylates Copolymer), which include for example the copolymers of methacrylic acid, butyl acrylate and methyl methacrylate (CAS Number according to Chemical Abstracts Service: 25035-69-2) or of butyl acrylate and methyl methacrylate (CAS 25852-37-3) and which are available for example from Rohm & Haas under the trade names Aculyn® and Acusol® as well as from Degussa (Goldschmidt) under the trade names Tego® Polymer, e.g. the anionic non-associative polymers Aculyn, Aculyn 25852-37-3, Aculyn 22, Acusol 28, Acusol 33 (crosslinked), Acusol 810 and Acusol 823 and Acusol 830 (CAS 25852-37-3); (ii) crosslinked high molecular weight acrylic acid copolymers that include, for example copolymers of C₁₀₋₃₀ alkyl acrylates and one or more monomers from the group of acrylic acid, methacrylic acid and their simple esters, preferably formed with C₁₋₄ alcohols, which are crosslinked with an allyl ether of saccharose or of pentaerythritol (INCI Acrylates/C10-30 Alkyl Acrylate Crosspolymer) and which are available from the Noveon Company under the trade name Carbopol®, e.g. the hydrophobized Carbopol ETD 2623 and Carbopol 1382 (INCI Acrylates/C 10-30 Alkyl Acrylate Crosspolymer) as well as Carbopol Aqua 30 (previously Carbopol EX 473).

Preferred liquid detergents and cleaning agents comprise the polyacrylate in an amount of 0.1 to 10 wt. % and preferably 2 to 5 wt. %.

Advantageously, the polyacrylate is a copolymer of an unsaturated mono- or dicarboxylic acid and one or more C₁-C₃₀ alkyl esters of (meth)acrylic acid.

In addition, the detergent and cleaning agent comprises a solvent component that comprises dipropylene glycol. The solvent component particularly preferably comprises dipropylene glycol and 1,2-propane diol. Quite particularly preferably, the solvent component consists of dipropylene glycol and 1,2-propane diol. The ratio of dipropylene glycol to 1,2-propane diol is advantageously between 3:1 and 1:3 and is quite particularly preferably 1:1. The quantity of the solvent component, based on the total quantity of the detergent and cleaning agent, is 0.5 to 15 wt. % and preferably 2 to 9 wt. %.

In addition to the thickener and the solvent component, the liquid detergents and cleaning compositions comprise surfactant(s), wherein anionic, non-ionic, cationic and/or amphoteric surfactants can be incorporated. Mixtures of anionic and non-ionic surfactants are preferred from the technical viewpoint. The total surfactant content of the liquid detergent and cleaning composition is preferably below 40 wt. % and particularly preferably below 35 wt. %, based on the total liquid detergent and cleaning composition.

Preferred non-ionic surfactants are alkoxylated, advantageously ethoxylated, particularly primary alcohols preferably containing 8 to 18 carbon atoms and, on average, 1 to 12 moles of ethylene oxide (EO) per mole of alcohol, in which the alcohol group may be linear or, preferably, methyl-branched in the 2-position or may contain e.g. linear and methyl-branched groups in the form of the mixtures typically present in oxo alcohol groups. Particularly preferred are, however, alcohol ethoxylates with linear alcohol groups of natural origin with 12 to 18 carbon atoms, e.g. from coco-, palm-, tallow- or oleyl alcohol, and an average of 2 to 8 EO per mole alcohol. Exemplary preferred ethoxylated alcohols include C₁₂₋₁₄ alcohols with 3 EO, 4 EO or 7 EO, C₉₋₁₁ alcohols with 7 EO, C₁₃₋₁₅ alcohols with 3 EO, 5 EO, 7 EO or 8 EO, C₁₂₋₁₈ alcohols with 3 EO, 5 EO or 7 EO and mixtures thereof, such as mixtures of C₁₂₋₁₄ alcohol with 3 EO and C₁₂₋₁₈ alcohol with 7 EO. The cited degrees of ethoxylation constitute statistically average values that can be a whole or a fractional number for a specific product. Preferred alcohol ethoxylates have a narrowed homolog distribution (narrow range ethoxylates, NRE). In addition to these non-ionic surfactants, fatty alcohols with more than 12 EO can also be used. Examples of these are tallow fatty alcohol with 14 EO, 25 EO, 30 EO or 40 EO. Also, non-ionic surfactants that comprise the EO and PO groups together in the molecule are employable according to the invention. Here, block copolymers with EO-PO blocks or PO-EO blocks can be added, but also EO-PO-EO copolymers or PO-EO-PO copolymers. Of course, mixed alkoxylated non-ionic surfactants can also be used, in which EO and PO units are not in blocks but rather distributed statistically. Such products can be obtained by the simultaneous action of ethylene oxide and propylene oxide on fatty alcohols.

Furthermore, as additional non-ionic surfactants, alkyl glycosides that satisfy the general Formula RO(G)ₓ can be added, where R means a primary linear or methyl-branched, particularly 2-methyl-branched, aliphatic group containing 8 to 22 and preferably 12 to 18 carbon atoms and G stands for a glycose unit containing 5 or 6 carbon atoms, preferably glucose. The degree of oligomerization x, which defines the distribution of monoglycosides and oligoglycosides, is any number between 1 and 10, preferably between 1.2 and 1.4.

Another class of preferred non-ionic surfactants which may be used, either as the sole non-ionic surfactant or in combination with other non-ionic surfactants, are alkoxylated, preferably ethoxylated or ethoxylated and propoxylated fatty acid alkyl esters preferably containing 1 to 4 carbon atoms in the alkyl chain, in particular fatty acid methyl esters.

Non-ionic surfactants of the amine oxide type, for example N-coco alkyl-N,N-dimethylamine oxide and N-tallow alkyl-N,N-dihydroxyethylamine oxide, and the fatty acid alkanolamides may also be suitable. The quantity in which these non-ionic surfactants are used is preferably no more than the quantity in which the ethoxylated fatty alcohols are used and, particularly no more than half that quantity.

Other suitable surfactants are polyhydroxyfatty acid amides corresponding to the Formula (2),

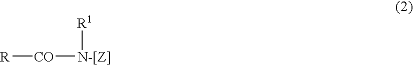

in which RCO stands for an aliphatic acyl group with 6 to 22 carbon atoms, R¹ for hydrogen, an alkyl or hydroxyalkyl group with 1 to 4 carbon atoms and [Z] for a linear or branched polyhydroxyalkyl group with 3 to 10 carbon atoms and 3 to 10 hydroxyl groups. The polyhydroxyfatty acid amides are known substances, which may normally be obtained by reductive amination of a reducing sugar with ammonia, an alkylamine or an alkanolamine and subsequent acylation with a fatty acid, a fatty acid alkyl ester or a fatty acid chloride.

The group of polyhydroxyfatty acid amides also comprises compounds corresponding to Formula (3),

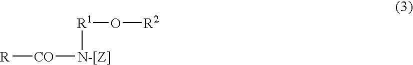

in which R is a linear or branched alkyl or alkenyl group containing 7 to 12 carbon atoms, R¹ is a linear, branched or cyclic alkyl group or an aryl group containing 2 to 8 carbon atoms and R² is a linear, branched or cyclic alkyl group or an aryl group or an oxyalkyl group containing 1 to 8 carbon atoms, C₁₋₄ alkyl or phenyl groups being preferred, and [Z] is a linear polyhydroxyalkyl group, of which the alkyl chain is substituted by at least two hydroxy groups, or alkoxylated, preferably ethoxylated or propoxylated derivatives of that group.

[Z] is preferably obtained by reductive amination of a sugar, for example glucose, fructose, maltose, lactose, galactose, mannose or xylose. The N-alkoxy- or N-aryloxy-substituted compounds may then be converted into the required polyhydroxyfatty acid amides by reaction with fatty acid methyl esters in the presence of an alkoxide as catalyst.

The content of non-ionic surfactants in the liquid detergents and cleaning compositions is preferably 5 to 30 wt. %, advantageously 7 to 20 wt. % and particularly 9 to 15 wt. %, in each case based on the total weight of the composition.

Exemplary suitable anionic surfactants are those of the sulfonate and sulfate type. Suitable surfactants of the sulfonate type are, advantageously C₉₋₁₃ alkylbenzene sulfonates, olefin sulfonates, i.e. mixtures of alkene- and hydroxyalkane sulfonates, and disulfonates, as are obtained, for example, from C₁₂₋₁₈ monoolefins having a terminal or internal double bond, by sulfonation with gaseous sulfur trioxide and subsequent alkaline or acidic hydrolysis of the sulfonation products. Those alkane sulfonates, obtained from C₁₂₋₁₈ alkanes by sulfochlorination or sulfoxidation, for example, with subsequent hydrolysis or neutralization, are also suitable. The esters of α-sulfofatty acids (ester sulfonates), e.g. the α-sulfonated methyl esters of hydrogenated coco-, palm nut- or tallow acids are likewise suitable.

Further suitable anionic surfactants are sulfated fatty acid esters of glycerine. They include the mono-, di- and triesters and also mixtures of them, such as those obtained by the esterification of a monoglycerine with 1 to 3 moles fatty acid or the transesterification of triglycerides with 0.3 to 2 moles glycerine. Preferred sulfated fatty acid esters of glycerol in this case are the sulfated products of saturated fatty acids with 6 to 22 carbon atoms, for example caproic acid, caprylic acid, capric acid, myristic acid, lauric acid, palmitic acid, stearic acid or behenic acid.

Preferred alk(en)yl sulfates are the alkali metal and especially sodium salts of the sulfuric acid half-esters derived from the C₁₂-C₁₈ fatty alcohols, for example from coconut butter alcohol, tallow alcohol, lauryl, myristyl, cetyl or stearyl alcohol or from C₁₀-C₂₀ oxo alcohols and those half-esters of secondary alcohols of these chain lengths. Additionally preferred are alk(en)yl sulfates of the said chain lengths, which contain a synthetic, straight-chained alkyl group produced on a petrochemical basis and which show similar degradation behavior to the suitable compounds based on fat chemical raw materials. The C₁₂-C₁₆ alkyl sulfates and C₁₂-C₁₅ alkyl sulfates and C₁₄-C₁₅ alkyl sulfates are preferred on the grounds of laundry performance. The 2,3-alkyl sulfates, which can be obtained for example from Shell Oil Company under the trade name DAN®, are also suitable anionic surfactants.

Sulfuric acid mono-esters derived from straight-chained or branched C₇₋₂₁ alcohols ethoxylated with 1 to 6 moles ethylene oxide are also suitable, for example 2-methyl-branched C₉₋₁₁ alcohols with an average of 3.5 mole ethylene oxide (EO) or C₁₂₋₁₈ fatty alcohols with 1 to 4 EO. Due to their high foaming performance, they are only used in fairly small quantities in cleaning compositions, for example in amounts of 1 to 5% by weight.

Other suitable anionic surfactants are the salts of alkylsulfosuccinic acid, which are also referred to as sulfosuccinates or esters of sulfosuccinic acid and the monoesters and/or diesters of sulfosuccinic acid with alcohols, preferably fatty alcohols and especially ethoxylated fatty alcohols. Preferred sulfosuccinates comprise C₈₋₁₈ fatty alcohol groups or mixtures of them. Especially preferred sulfosuccinates comprise a fatty alcohol group derived from ethoxylated fatty alcohols and may be considered as non-ionic surfactants (see description below). Once again the especially preferred sulfosuccinates are those, whose fatty alcohol groups are derived from ethoxylated fatty alcohols with narrow range distribution. It is also possible to use alk(en)ylsuccinic acids with preferably 8 to 18 carbon atoms in the alk(en)yl chain, or salts thereof.

Particularly preferred anionic surfactants are soaps. Saturated and unsaturated fatty acid soaps are suitable, such as the salts of lauric acid, myristic acid, palmitic acid, stearic acid, (hydrogenated) erucic acid and behenic acid, and especially soap mixtures derived from natural fatty acids such as coconut oil fatty acid, palm kernel oil fatty acid, olive oil fatty acid or tallow fatty acid.

Anionic surfactants, including soaps may be in the form of their sodium, potassium or ammonium salts or as soluble salts of organic bases, such as mono-, di- or triethanolamine. Preferably, the anionic surfactants are in the form of their sodium or potassium salts, especially in the form of the sodium salts.

The content of anionic surfactants in the preferred liquid detergents and cleaning composition is 2 to 30 wt. %, preferably 4 to 25 wt. % and particularly 5 to 22 wt. %, in each case based on the total weight of the composition. It is particularly preferred that the amount of fatty acid soap is at least 2 wt. % and particularly preferably at least 3 wt. % and especially preferably at least 4 wt. %.

The viscosity of the liquid detergents and cleaning compositions can be measured using standard methods (for example using a Brookfield Viscosimeter LVT-11 at 20 rpm and 20° C., spindle 3) and lies preferably in the range from 1500 to 5000 mPas. Preferred compositions have viscosities from 2000 to 4000 mPas, particularly preferably approximately 3500 mPas.

In addition to the polyacrylate thickener, the solvent component and to the surfactant(s), the liquid detergents and cleaning compositions can comprise additional ingredients that further improve the application technological and/or esthetic properties of the liquid detergent and cleaning composition. In the context of the present invention, preferred agents can comprise one or a plurality of materials from the group of builders, bleaches, bleach activators, enzymes, electrolytes, additional non-aqueous solvents, pH adjustors, fragrances, perfume carriers, fluorescent agents, dyes, hydrotropes, foam inhibitors, silicone oils, anti-redeposition agents, optical brighteners, graying inhibitors, laddering retardants, anti-crease agents, color transfer inhibitors, antimicrobials, germicides, fungicides, antioxidants, corrosion inhibitors, antistats, ironing aids, water-repellents and impregnation agents, swelling and non-skid agents and UV-absorbers.

Silicates, aluminum silicates (particularly zeolites), carbonates, salts of organic di- and polycarboxylic acids as well as mixtures of these materials can be particularly cited as builders that are comprised in the liquid detergents and cleaning compositions.

Suitable crystalline, layered sodium silicates correspond to the general formula NaMSiₓO₂ₓ₊₁H₂O, wherein M is sodium or hydrogen, x is a number from 1.9 to 4 and y is a number from 0 to 20, preferred values for x being 2, 3 or 4. Preferred crystalline layered silicates of the given formula, are those in which M stands for sodium and x assumes the values 2 or 3.

Both β- and δ-sodium disilicates Na₂Si₂O₅ yH₂O are preferred.

Other useful builders are amorphous sodium silicates with a modulus (Na₂O:SiO₂ ratio) of 1:2 to 1:3.3, preferably 1:2 to 1:2.8 and more preferably 1:2 to 1:2.6, which dissolve with a delay and exhibit multiple wash cycle properties. The delay in dissolution compared with conventional amorphous sodium silicates can have been obtained in various ways, for example by surface treatment, compounding, compressing/compacting or by over-drying. In the context of this invention, the term “amorphous” also means “X-ray amorphous”. In other words, the silicates do not produce any of the sharp X-ray reflections typical of crystalline substances, but at best one or more maxima of the scattered X-radiation, which have a width of several degrees of the diffraction angle. However, particularly good builder properties may even be achieved where the silicate particles produce indistinct or even sharp diffraction maxima in electron diffraction experiments. This can be interpreted to mean that the products have microcrystalline regions between 10 and a few hundred nm in size, values of up to at most 50 nm and especially up to at most 20 nm being preferred. These types of X-ray amorphous silicates similarly exhibit a delayed dissolution in comparison with the customary water glasses. Compacted/densified amorphous silicates, compounded amorphous silicates and over dried X-ray-amorphous silicates are particularly preferred.

Of the suitable fine crystalline, synthetic zeolites containing bound water, zeolite A and/or P are preferred. Zeolite MAP® (commercial product of the Crosfield company), is particularly preferred as the zeolite P. However, zeolite X and mixtures of A, X, Y and/or P are also suitable. Commercially available and preferably used in the context of the present invention is, for example, also a co-crystallizate of zeolite X and zeolite A (ca. 80 wt. % zeolite X), which is marketed by the SASOL Company under the trade name VEGOBOND AX® and which can be described by the Formula

nNa₂O.(1−n)K₂O.Al₂O₃.(2-2.5)SiO₂.(3.5-5.5)H₂O
n=0.90-1.0

The zeolite can be employed as the spray-dried powder or also as the non-dried, still moist from its manufacture, stabilized suspension. For the case where the zeolite is added as a suspension, this can comprise small amounts of non-ionic surfactants as stabilizers, for example 1 to 3 wt. %, based on the zeolite, of ethoxylated C₁₂-C₁₈ fatty alcohols with 2 to 5 ethylene oxide groups, C₁₂-C₁₄ fatty alcohols with 4 to 5 ethylene oxide groups or ethoxylated isotridecanols. Suitable zeolites have an average particle size of less than 10 μm (test method: volumetric distribution Coulter counter) and preferably comprise 18 to 22 wt. %, particularly 20 to 22 wt. % of bound water.

Naturally, the generally known phosphates can also be added as builders, in so far that their use should not be avoided on ecological grounds. The sodium salts of the orthophosphates, the pyrophosphates and especially the tripolyphosphates are particularly suitable.

Among the compounds, which serve as bleaching agents and liberate H₂O₂ in water, sodium perborate tetrahydrate and sodium perborate monohydrate are of particular importance. Examples of further bleaching agents that may be employed are sodium percarbonate, peroxypyrophosphates, citrate perhydrates and H₂O₂-liberating peracidic salts or peracids, such as perbenzoates, peroxyphthalates, diperoxyazelaic acid, phthaloimino peracid or diperoxydodecanedioic acid.

The detergents and cleaning compositions can comprise bleach activators in order to achieve an improved bleaching action for washing temperatures of 60° C. and below. Bleach activators that can be used are compounds which, under perhydrolysis conditions, yield aliphatic peroxycarboxylic acids having preferably 1 to 10 carbon atoms, in particular 2 to 4 carbon atoms, and/or optionally substituted perbenzoic acid. Substances, which carry O-acyl and/or N-acyl groups of said number of carbon atoms and/or optionally substituted benzoyl groups, are suitable. Preference is given to polyacylated alkylenediamines, in particular tetraacetyl ethylenediamine (TAED), acylated triazine derivatives, in particular 1,5-diacetyl-2,4-dioxohexahydro-1,3,5-triazine (DADHT), acylated glycolurils, in particular tetraacetyl glycoluril (TAGU), N-acylimides, in particular N-nonanoyl succinimide (NOSI), acylated phenol sulfonates, in particular n-nonanoyl- or iso-nonanoyloxybenzene sulfonate (n- or iso-NOBS), carboxylic acid anhydrides, in particular phthalic anhydride, acylated polyhydric alcohols, in particular triacetin, ethylene glycol diacetate and 2,5-diacetoxy-2,5-dihydrofuran.

In addition to, or instead of the conventional bleach activators, so-called bleach catalysts may also be incorporated into the liquid detergents and cleaning compositions. These substances are bleach-boosting transition metal salts or transition metal complexes such as, for example, manganese-, iron-, cobalt-, ruthenium- or molybdenum-salen complexes or -carbonyl complexes. Manganese, iron, cobalt, ruthenium, molybdenum, titanium, vanadium and copper complexes with nitrogen-containing tripod ligands and cobalt-, iron-, copper- and ruthenium-amine complexes may also be used as bleach catalysts.

Suitable enzymes are, in particular, those from the classes of hydrolases, such as proteases, esterases, lipases or lipolytic enzymes, amylases, cellulases or other glycosyl hydrolases and mixtures thereof. In the wash, all these hydrolases contribute to the removal of stains such as protein, fat or starchy stains and against graying. Moreover, cellulases and other glycosyl hydrolases can contribute to increased softness of the textile and to color retention by removing pilling and micro fibrils. Oxireductases can also be added for bleaching or for reducing color transfer. Enzymatic active materials obtained from bacterial sources or fungi such as bacillus subtilis, bacillus licheniformis, streptomyceus griseus and humicola insolens are particularly well suited. Proteases of the subtilisin type and particularly proteases that are obtained from bacillus lentus, are preferably used. Here, mixtures of enzymes are of particular interest, for example proteases and amylases or proteases and lipases or lipolytic enzymes or proteases and cellulases or cellulases and lipases or lipolytic enzymes or proteases, amylases and lipases or lipolytic enzymes or proteases, lipases or lipolytic enzymes and cellulases, in particular, however proteases and/or lipase-containing mixtures or mixtures with lipolytic enzymes. Examples of such lipolytic enzymes are the known cutinases. Peroxidases or oxidases have also proved to be suitable in certain cases. The suitable amylases particularly include α-amylases, iso-amylases, pullulanases and pectinases. Cellobiohydrolases, endoglucanases and β-glucosidases, which are also known as cellobiases, or mixtures thereof, are preferred cellulases. As the different cellulase types differ in their CMCase- and avicelase activities, the required activities can be adjusted by means of controlled mixtures of the cellulases.

The enzymes can be adsorbed on carriers in order to protect them against premature decomposition. The content of the enzymes, enzyme liquid formulations, enzyme mixtures or enzyme granules may be, for example, about 0.1 to 5% by weight and is preferably 0.12 to about 2.5% by weight.

A large number of the most varied salts can be employed from the group of the inorganic salts as the electrolyte. Preferred cations are the alkali and alkali earth metals, preferred anions are the halides and sulfates. The addition of NaCl or MgCl₂ to the agents is preferred from the industrial manufacturing point of view. The content of electrolytes in the agents normally ranges from 0.5 to 5 wt. %.

The clear, liquid detergents and cleaning agents are particularly preferably aqueous, i.e. they possess a water content of greater than 5 wt. %, preferably greater than 15 wt. % and particularly preferably greater than 25 wt. %.

Additional non-aqueous solvents that can be incorporated in the liquid detergents and cleaning compositions originate for example from the group of mono- or polyhydric alcohols, alkanolamines or glycol ethers, in so far that they are miscible with water in the defined concentration range. Preferably, the solvents are selected from ethanol, n- or i-propanol, butanols, glycol, butane diol, glycerine, diglycol, butyl diglycol, hexylene glycol, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl-, -ethyl- or -propyl ether, dipropylene glycol monomethyl-, or -ethyl ether, diisopropylene glycol monomethyl-, or -ethyl ether, methoxy-, ethoxy- or butoxy triglycol, 1-butoxyethoxy-2-propanol, 3-methyl-3-methoxybutanol, propylene glycol t-butyl ether as well as mixtures of these solvents. These additional non-aqueous solvents can be incorporated in the liquid detergent and cleaning compositions in amounts between 0.5 and 8 wt. %, preferably, however below 5 wt. % and particularly below 3 wt. %. These amounts are independent of the amount of the solvent component in the liquid detergent and cleaning compositions.

The addition of pH adjustors can be considered for bringing the pH of the detergent and cleaning composition into the desired range. Any known acid or alkali can be added, in so far as their addition is not forbidden on technological or ecological grounds or grounds of protection of the consumer. The amount of these adjustors does not normally exceed 10 wt. % of the total formulation.

Another preferred component of the present invention is a hydrotrope. Preferred hydrotropes comprise the sulfonated hydrotropes, such as, for example the alkylaryl sulfonates or alkylaryl sulfonic acids.

Preferred hydrotropes are selected from the sulfonates or sulfonic acids of xylene, toluene, cumene, naphthalene, and mixtures thereof. The counter ions are preferably selected from sodium, calcium and ammonium. The liquid detergent and cleaning agent can typically comprise 0.01 to 20 wt. % of a hydrotrope, more preferably 0.05 to 10 wt. % and most preferably 0.1 to 5 wt. %.

In order to enhance the esthetic impression of the liquid detergent and cleaning composition, they may be colored with appropriate colorants. Preferred colorants, which are not difficult for the expert to choose, have high storage stability, are not affected by the other ingredients of the detergents or by light and do not have any pronounced substantivity for the textile fibers being treated, so as not to color them.

Soaps, paraffins or silicone oils, optionally deposited on carrier materials, are examples of the foam inhibitors that can be added to the liquid detergents and cleaning compositions. Suitable anti-redeposition agents, also referred to as soil repellents are, for example, non-ionic cellulose ethers such as methyl cellulose and methyl hydroxypropyl cellulose with a content of methoxy groups of 15 to 30 wt. % and hydroxypropyl groups of 1 to 15 wt. %, each based on the non-ionic cellulose ether, as well as polymers of phthalic acid and/or terephthalic acid or their derivatives known from the prior art, particularly polymers of ethylene terephthalates and/or polyethylene glycol terephthalates or anionically and/or non-ionically modified derivatives thereof. From these, the sulfonated derivatives of the phthalic acid polymers and the terephthalic acid polymers are particularly preferred.

Optical brighteners (so called “whiteners”) can be added to the liquid detergents and cleaning compositions in order to eliminate graying and yellowing of the treated textile fabrics. These materials absorb onto the fiber and effect a brightening and pseudo bleach effect in that the invisible ultraviolet radiation is converted into visible radiation, wherein the ultraviolet light absorbed from sunlight is irradiated away as weak blue fluorescence and results in pure white for the yellow shade of the grayed or yellowed washing. Suitable compounds derive for example from the substance classes of 4,4′-diamino-2,2′-stilbenedisulfonic acids (flavonic acids), 4,4′-distyrylbiphenylene, methylumbelliferone, coumarone, dihydroquinolinones, 1,3-diarylpyrazolines, naphthoic acid imides, benzoxazole-, benzisoxazole- and benzimidazole-systems as well as heterocyclic substituted pyrene derivatives. The optical brighteners are usually added in amounts between 0.03 and 0.3 wt. %, based on the finished agent.

Graying inhibitors have the function of maintaining the dirt that was removed from the fibers suspended in the washing liquor, thereby preventing the dirt from resettling. Water-soluble colloids of mostly organic nature are suitable for this, for example glue, gelatins, salts of ether sulfonic acids of starches or celluloses, or salts of acidic sulfuric acid esters of celluloses or starches. Water-soluble, acid group-containing polyamides are also suitable for this purpose. In addition, soluble starch preparations and others can be used as the abovementioned starch products, for example degraded starches, aldehyde starches etc. Polyvinyl pyrrolidone can also be used. Preference, however, is given to the use of cellulose ethers such as carboxymethyl cellulose (Na salt), methyl cellulose, hydroxyalkyl cellulose and mixed ethers such as methyl hydroxyethyl cellulose, methyl hydroxypropyl cellulose, methyl carboxymethyl cellulose and mixtures thereof, which can be added, for example in amounts of 0.1 to 5 wt. %, based on the agent.

As textile fabrics, particularly of rayon, spun rayon, cotton and their mixtures, can wrinkle of their own accord because the individual fibers are sensitive to flection, bending, pressing and squeezing at right angles to the fiber direction, the agents can comprise synthetic wrinkle-protection agents. They include for example synthetic products based on fatty acids, fatty acid esters, fatty acid amides, fatty acid alkylol esters, fatty acid alkylol amides or fatty alcohols that have been mainly treated with ethylene oxide, or products based on lecithin or modified phosphoric acid esters.

The liquid detergents and cleaning compositions can comprise antimicrobials to combat microorganisms. Depending on the antimicrobial spectrum and the action mechanism, antimicrobial agents are classified as bacteriostatic agents and bactericides, fungistatic agents and fungicides, etc. Important representatives of these groups are, for example, benzalkonium chlorides, alkylaryl sulfonates, halophenols and phenol mercuric acetate, wherein the use of these compounds can also be totally dispensed with in the inventive compositions.

The agents can comprise antioxidants in order to prevent undesirable changes caused by oxygen and other oxidative processes to the liquid detergents and cleaning agents and/or the treated textile fabrics. This class of compounds comprises, for example, substituted phenols, hydroquinones, pyrocatechols and aromatic amines as well as organic sulfides, polysulfides, dithiocarbamates, phosphites and phosphonates.

An increased wear comfort can result from the additional use of antistats that can be additionally included in the agents. Antistats increase the surface conductivity and thereby allow an improved discharge of built-up charges. Generally, external antistats are substances with at least one hydrophilic molecule ligand and provide a more or less hygroscopic film on the surfaces. These mainly interface active antistats can be subdivided into nitrogen-containing (amines, amides, quaternary ammonium compounds), phosphorus-containing (phosphoric acid esters) and sulfur-containing (alkyl sulfonates, alkyl sulfates) antistats. Exemplary external antistats are lauryl (or stearyl) dimethyl benzyl ammonium chlorides and are suitable antistats for textile fabrics or as additives to detergents, resulting in an additional finishing effect.

Silicone derivatives, for example, can be incorporated in the liquid detergents and cleaning compositions to improve the water-absorption capacity, the re-wettability of the treated textile fabrics and to facilitate ironing of the treated fabrics. They additionally improve the final rinse behavior of the agents by means of their foam-inhibiting properties. Exemplary preferred silicone derivatives are polydialkylsiloxanes or alkylarylsiloxanes, in which the alkyl groups possess one to five carbon atoms and are totally or partially fluorinated. Preferred silicones are polydimethylsiloxanes that can be optionally derivatized and then are aminofunctional or quaternized or possess Si—OH, Si—H and/or SiCl bonds. The viscosities of the preferred silicones at 25° C. are in the range between 100 and 100 000 mPas, wherein the silicones can be added in amounts between 0.2 and 5 wt. %, based on the total agent.

Finally, the liquid detergents and cleaning compositions can also comprise UV absorbers that are absorbed on the treated textile fabrics and improve the light stability of the fibers. Compounds, which possess these desired properties, are for example, the efficient radiationless deactivating compounds and derivatives of benzophenone having substituents in position(s) 2 and/or 4. Also suitable are substituted benzotriazoles, acrylates that are phenyl-substituted in position 3 (cinnamic acid derivatives), optionally with cyano groups in position 2, salicylates, organic Ni complexes, as well as natural substances such as umbelliferone and the endogenous urocanic acid.

Substances can be added to complex heavy metals in order to prevent heavy metal catalyzed decomposition of certain detergent ingredients. Suitable heavy metal sequestrants are, for example, the alkali metal salts of ethylenediamine tetraacetic acid (EDTA) or of nitrilotriacetic acid (NTA) as well as alkali metal salts of anionic polyelectrolytes such as polymaleates and polysulfonates.

A preferred class of sequestrants are the phosphonates that are comprised in the preferred liquid detergents and cleaning compositions in amounts of 0.01 to 2.5 wt. %, preferably 0.02 to 2 wt. % and particularly 0.03 to 1.5 wt. %. These preferred compounds particularly include organophosphonates such as for example 1-hydroxyethane-1,1-diphosphonic acid (HEDP), amino tri(methylenephosphonic acid) (ATM P), d iethylenetriamine penta(methylenephosphonic acid) (DTPMP or DETPMP) as well as 2-phosphonobutane-1,2,4-tricarboxylic acid (PBS-AM), which are mainly added in the form of their ammonium or alkali metal salts.

The resulting liquid detergents and cleaning compositions are preferably clear, i.e. they do not exhibit any sediment and are preferably transparent or at least translucent. Preferably, the liquid detergent and cleaning agents—without the addition of a colorant—exhibit a transmission of visible light (410 to 800 nm) of at least 30%, preferably at least 50% and particularly preferably at least 75%.

In addition to these ingredients, a liquid detergent and cleaning agent can comprise dispersed particles whose diameter along the largest dimension ranges from 0.01 to 10000 μm.

In the context of this invention, particles can be microcapsules or speckles and also granulates, compounds and fragrance bubbles, microcapsules or speckles being preferred.

The term “microcapsule” is understood to mean aggregates that comprise at least one solid or liquid core that is encapsulated by at least one continuous casing, particularly a casing of polymer(s). They usually concern finely dispersed liquid or solid phases that are encapsulated by film-forming polymers, whereby during production, the polymers, after emulsification and coacervation or interfacial polymerization, precipitate out on the material being encapsulated. The microscopically small capsules can be dried like powders. Besides single-core microcapsules, multi-core aggregates—also called microspheres—are also known and comprise two or more cores arranged in the continuous encapsulating material. Moreover, single- or multi-core microcapsules can be encapsulated by an additional second, third etc. casing. Single-core microcapsules with a continuous casing are preferred. The casing can consist of natural, semi-synthetic or synthetic materials. Exemplary natural casing materials are gum arabicum, agar agar, agarose, maltodextrins, alginic acid or its salts, e.g. sodium or calcium alginate, fats and fatty acids, cetyl alcohol, collagen, chitosan, lecithin, gelatin, albumin, shellac, polysaccharides, such as starch or dextran, sucrose and waxes. Semi-synthetic casing materials include inter alia chemically modified celluloses, particularly cellulose esters and ethers, e.g. cellulose acetate, ethyl cellulose, hydroxypropyl cellulose, hydroxypropyl methyl cellulose and carboxymethyl cellulose as well as starch derivatives, particularly starch ethers and esters. Exemplary synthetic casing materials are polymers such as polyacrylates, polyamides, polyvinyl alcohol or polyvinyl pyrrolidone.

Sensitive, chemically or physically incompatible and volatile components (=active substances) of the liquid detergent and cleaning agent are advantageously encapsulated inside the microcapsules and are storage and transport-stable. Optical brighteners, surfactants, sequestrants, bleaching agents, bleach activators, dyes, fragrances, antioxidants, builders, enzymes, enzyme stabilizers, antimicrobials, graying inhibitors, anti-redeposition agents, pH adjustors, electrolytes, foam inhibitors and UV absorbers are examples of materials that can be found in the microcapsules. In addition to the abovementioned constituents that are not ingredients of the inventive aqueous liquid detergents and cleaning agents, the microcapsules can comprise for example cationic surfactants, vitamins, proteins, preservatives, boosters or pearlizers. The contents of the microcapsules can be solids or liquids in the form of solutions or emulsions or suspensions.

In the scope of the manufacturing process, the microcapsules can have any shape, however, they are preferably approximately spherical. Their diameter along the greatest spatial dimension can be between 0.01 μm (not visually recognizable as capsules) and 10000 μm depending on the encapsulated components and the application. Visible microcapsules with a diameter in the range 100 μm to 7000 μm, particularly 400 μm to 5000 μm, are preferred The microcapsules can be obtained by means of processes known from the prior art, wherein coacervation and interfacial polymerization have the most importance. All the commercially available, surfactant-stable microcapsules can be used as the microcapsules, for example the commercial products (the casing/encapsulating material is given in each case in brackets) Hallcrest Microcapsules (gelatin, gum Arabicum), Coletica Thalaspheres (maritime collagen), Lipotec Millicapseln (alginic acid, agar-agar), Induchem Unispheres (lactose, microcrystalline cellulose, hydroxypropyl methyl cellulose); Unicerin C30 (lactose, microcrystalline cellulose, hydroxypropyl methyl cellulose), Kobo Glycospheres (modified starch, fatty acid ester, phospholipids), Softspheres (modified agar agar) and Kuhs Probiol Nanospheres (phospholipids).

Alternatively, particles can also be used that do not have a core-casing structure, but rather in which the active substance is dispersed in a matrix of a matrix-forming material. Such particles are also referred to as “speckles”.

A preferred matrix-forming material is alginate. Alginate-based speckles are manufactured by dropping an aqueous alginate solution that also comprises the encapsulatable active substances or substances, followed by hardening in a precipitation bath containing Ca²⁺ ions or Al³⁺ ions.

It can be advantageous to subsequently wash the alginate-based speckles with water and then wash them again in an aqueous solution with a sequestrant so as to wash out free Ca²⁺ ions or free Al³⁺ ions that could cause undesirable interactions with the ingredients, e.g. the fatty acid soaps of the liquid detergent and cleaning agent. Finally, the alginate-based speckles are washed again with water to remove excess sequestrant.

Alternatively, other matrix-forming materials can be used instead of alginate. Examples of matrix-forming materials comprise polyethylene glycol, polyvinyl pyrrolidone, polymethacrylate, polylysin, polyoxamer, polyvinyl alcohol, polyacrylic acid, polyethylene oxide, polyethoxyoxazoline, albumin, gelatin, acacia, chitosan, cellulose, dextran, Ficoll®, starch, hydroxyethyl cellulose, hydroxypropyl cellulose, hydroxypropyl methylcellulose, hyaluronic acid, carboxymethyl cellulose, carboxymethyl cellulose, deacetylated chitosan, dextran sulfate and derivatives of these materials. These materials form matrices, for example by gelation, polyanion-polycation interactions or polyelectrolyte-metal ion interactions and, exactly like the manufacture of particles, the use of these matrix-forming materials is well known from the prior art.

The particles can be dispersed in the liquid detergent and cleaning composition to afford a stable dispersion. Stable means that the compositions are stable at room temperature and at 40° C. for a period of at least 4 weeks and preferably for at least 6 weeks without the agents creaming or precipitating.

The release of the active substances from the microcapsules or speckles normally occurs during the use of the agent including them by destruction of the casing or matrix from mechanical, thermal, chemical or enzymatic action. In a preferred embodiment of the invention, the liquid detergents and cleaning compositions comprise the same or different particles in amounts of 0.01 to 10 wt. %, particularly 0.2 to 8 wt. % and most preferably 0.5 to 5 wt. %.

The inventive detergents and cleaning compositions can be used for cleaning textile fabrics and/or hard surfaces.

For manufacturing the liquid detergent and cleaning agent, the acidic components, such as for example the linear alkylsulfonates, citric acid, boric acid, phosphonic acid, the fatty alcohol ether sulfates, etc., and the non-ionic surfactants are introduced. Preferably, the solvent component is also added at this time, although it can also be added later. The polyacrylate is added to these components. A base, such as for example NaOH, KOH, triethanolamine or monoethanolamine, is then added, followed by the fatty acid, when present. Subsequently, the remaining ingredients and the solvents of the aqueous liquid detergent and cleaning agent are added to the mixture and the pH is adjusted to about 8.5. Finally, the particles to be dispersed are added and dispersed homogeneously in the aqueous liquid detergent and cleaning composition with stirring and/or mixing.

### EXAMPLES

The Inventive detergents and cleaning compositions E1 to E5, together with a comparative example V1, are shown in Table 1. The resulting detergents and cleaning agents E1 to E5 were clear, had a viscosity of about 3000 mPas and a flow limit >0.6 Pa. The pH of the liquid detergents and cleaning compositions was approx. 8.5. All data are in weight percent, each based on the total composition.

TABLE 1

| | V1 | E1 | E2 | E3 | E4 | E5 |
|---|---|---|---|---|---|---|
| 1,2-Propane diol | 8 | 0 | 2 | 6 | 4 | 2 |
| Dipropylene glycol | 0 | 8 | 6 | 2 | 4 | 2 |
| Polyacrylate | 3 | 3 | 3 | 3 | 3 | — |
| (Carbopol Aqua 30) | | | | | | |
| Polyacrylate | — | — | — | — | — | 1.8 |
| (Polygel W301) | | | | | | |
| C₁₂₋₁₄ Fatty | 10 | 10 | 10 | 10 | 10 | 10 |
| alcohol with 7 EO | | | | | | |
| C₉₋₁₃ Alkylben- | 10 | 10 | 10 | 10 | 10 | |
| zenesulfonate, Na | | | | | | |
| salt | | | | | | |
| Citric acid | 3 | 3 | 3 | 3 | 3 | 2 |
| Dequest ® 2010 | 1 | 1 | 1 | 1 | 1 | — |
| Dequest ® 2066 | — | — | — | — | — | 0.7 |
| Sodium lauryl | 10 | 10 | 10 | 10 | 10 | 5 |
| ether sulfate with | | | | | | |
| 2 EO | | | | | | |
| Monoethanolamine | 3 | 3 | 3 | 3 | 3 | 2 |
| C₁₂₋₁₈ Fatty | 5.5 | 5.5 | 5.5 | 5.5 | 5.5 | 5.5 |
| acid, Na salt | | | | | | |
| Enzymes, color- | + | + | + | + | + | + |
| ants, stabilizers | | | | | | |
| Microcapsules | 0.5 | 0.5 | 0.5 | 0.5 | 0.5 | 0.5 |
| with ca. 2000 μm | | | | | | |
| Φ | | | | | | |
| Water | ad | ad | ad | ad | ad | ad |
| | 100 | 100 | 100 | 100 | 100 | 100 |
| Flow limit (Pa) | 0.4 | 0.6 | 0.6 | 0.8 | 1.0 | 0.6 |
| Appearance | cloudy | clear | clear | clear | clear | clear |

Dequest ® 2010: hydroxyethylidene-1,1-diphosphonic acid, tetra Na salt (ex Solutia)
Dequest ® 2066: diethylenetriamine penta(methylenephosphonic acid), hepta Na salt (ex Solutia)

The flow limits were determined with a Rheometer AR 1000-N from Texas Instruments at a temperature of 25° C.

The four detergents and cleaning compositions E1 to E5 were stable at room temperature and at 40° C. for more than 8 weeks.

The examples clearly show that the use of dipropylene glycol and especially the use of dipropylene glycol and 1,2-propane diol as the solvent component in combination with an acrylate thickener has a synergistic affect and leads to a thickened clear detergent and cleaning composition with a high flow limit.

From the comparative test V1 it is also clear that the use of 1,2-propane diol alone yields cloudy compositions with a flow limit.

1. Clear, liquid detergent and cleaning agent having a flow limit, which comprises surfactant(s) as well as further conventional ingredients of detergents and cleaning agents, wherein the agent comprises a polyacrylate and a solvent component including dipropylene glycol.

2. Clear, liquid detergent and cleaning agent according to claim 1, wherein the solvent component comprises a mixture of dipropylene glycol and 1,2-propane diol.

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. Clear, liquid detergent and cleaning agent according to claim 2, wherein the ratio of dipropylene glycol to 1,2-propane diol is 3:1 to 1:3.

15. Clear, liquid detergent and cleaning agent according to claim 2, wherein the ratio of dipropylene glycol to 1,2-propane diol is 1:1.

16. Clear, liquid detergent and cleaning agent according to claim 1, wherein the quantity of the solvent component is 0.5 to 15 wt. %.

17. Clear, liquid detergent and cleaning agent according to claim 1, wherein the quantity of the solvent component is 2 to 9 wt. %.

18. Clear, liquid detergent and cleaning agent according to claim 1, wherein the quantity of polyacrylate is 0.1 to 10 wt. %.

19. Clear, liquid detergent and cleaning agent according to claim 1, wherein the quantity of polyacrylate is 2 to 5 wt. %.

20. Clear, liquid detergent and cleaning agent according to claim 1, wherein the polyacrylate is a copolymer of one or more unsaturated mono- or dicarboxylic acids and one or more C₁-C₃₀ alkyl esters of (meth)acrylic acid.

21. Clear, liquid detergent and cleaning composition according claim 1, wherein the detergent and cleaning composition is aqueous.

22. Clear, liquid detergent and cleaning composition according to claim 1, wherein the detergent and cleaning composition comprises dispersed particles, whose diameter along the greatest spatial dimension is 0.01 to 10000 μm.

23. Clear, liquid detergent and cleaning composition according to claim 22, wherein the dispersed particles are microcapsules or speckles.

24. Clear, liquid detergent and cleaning composition according to claim 1, wherein the detergent and cleaning composition comprises between 2 and 20 wt. % fatty acid soap.

25. Clear, liquid detergent and cleaning composition according to claim 1, wherein the detergent and cleaning composition comprises between 3 and 10 wt. % fatty acid soap.

26. Clear, liquid detergent and cleaning composition according to claim 1, wherein the detergent and cleaning composition comprises between 4 and 8 wt. % fatty acid soap.

27. A method for cleaning textile surfaces or hard surfaces comprising a clear, liquid detergent and cleaning agent according to claim 1.

28. A process for manufacturing a clear, liquid detergent and cleaning agent, comprising one or more surfactants and further conventional ingredients of detergents and cleaning agents, into which is incorporated a polyacrylate and a solvent component that comprises dipropylene glycol.

29. A method for manufacturing a clear, liquid detergent and cleaning agent having a flow limit, in which is incorporated a polyacrylate and a solvent component that comprises dipropylene glycol.
